(19) United States
(12) Patent Application Publication
(10) Pub. No.: US 2020/0284390 A1
(43) Pub. Date: Sep. 10, 2020

(54) ROTATABLE INSPECTION MODULE AND METHOD FOR INSPECTING THE CONDITIONS OF THE WALL OF A PIPELINE

(71) Applicant: Pure Technologies Ltd., Calgary (CA)

(72) Inventor: Jeffrey Chak-Fai KWAN, Markham (CA)

(21) Appl. No.: 16/811,707

(22) Filed: Mar. 6, 2020

Related U.S. Application Data
(60) Provisional application No. 62/814,638, filed on Mar. 6, 2019.

(51) Int. Cl. F16L 55/40; F16L 55/30

(52) U.S. Cl. CPC F16L 55/40; F16L 2101/30; F16L 55/30

(57) ABSTRACT

A rotatable pipeline inspection module assesses the condition of a pipeline wall when the module is deployed into a pipeline containing a liquid. The module includes at least one sensor, the sensor configured to collect information useful for assessing the condition of a pipeline wall as the sensor is moved within the pipeline. A body is configured to mount the at least one sensor. The module is operatively securable to a cable for tethering the module to a location outside of the pipeline. The body is actuatable to rotate in relation to the module when the module is secured to the cable.

### CROSS REFERENCE TO RELATED APPLICATIONS

This application claims the benefit of Ser. No. 62/814,638, filed Mar. 6, 2019 in the United States and is incorporated herein by reference. To the extent appropriate, a claim of priority is made to the above-disclosed application.

### TECHNICAL FIELD

The present invention relates to pipeline inspection devices and methods of using same.

### BACKGROUND

Pipeline inspection devices are used to inspect the condition of the walls of the pipeline. Some known pipeline inspection devices used to assess the condition of the underground pipeline require excavation of the ground to expose the exterior of the pipeline.

Some pipeline inspection devices can operate inside the pipeline. In these cases, some of these devices will require the full or partial removal of the liquid in the pipeline in order to operate. Furthermore, there are some known devices that require access to the full diameter of the pipeline and such devices are difficult to insert, retract, and may require removing a pipe section or using a pressurized container for inserting full diameter inspection tools into the pipeline such as for example, a pig launcher.

There is a need to provide pipeline inspection devices and methods of pipeline inspection which allow for the inspection of the entire interior surface of the pipeline during flow conditions and which allow for the deployment in those pipelines that have various bends and inline valves.

### SUMMARY OF THE INVENTION

It is an embodiment of the present invention to provide a pipeline inspection device and methods of using same to inspect the condition of the pipeline.

According to one aspect, the pipeline inspection device is deployable into the pipeline and comprises one or more modules for collecting information about the condition of the pipeline, specifically, for collecting information about various defects in the wall of the pipeline.

According to one aspect, there is provided a module securable to the pipeline inspection device, the module including equipment configured to detect one or more defects in a pipeline.

In one aspect, the module is configured to orient one or more equipment into a desired orientation to improve aspects of the collected information.

In one aspect, the module is configured to rotate the equipment about a longitudinal axis and/or to move the equipment into the desired position. In one aspect, the module is configured to move the equipment from a collapsed position close to the body of the module to an expanded position away from the body of the module to improve aspects of the collected information.

In one aspect, the equipment is a sensor. In further aspects, the sensor is a transducer and the provision of the ability to rotate and/or extend the transducers away from the body of the module improves the resolution of the transducers.

In one embodiment, there is provided a rotatable pipeline inspection module to assess the condition of a pipeline wall when the module is deployed into a pipeline containing a liquid, the module comprising:
at least one sensor, the sensor configured to collect information useful for assessing the condition of a pipeline wall as the sensor is moved within the pipeline; and
a body configured to mount the at least one sensor, wherein the modules is operatively securable to a cable for tethering the module to a location outside of the pipeline; and wherein the body is actuatable to rotate in relation to the module when the module is secured to the cable.

In one aspect, the module comprises a first and a second end opposed to the first end, wherein the body is located between and moveable in relation to the ends, and wherein the cable is secured to one of the first and second ends. The module further comprises an intermediate portion between the first and second ends, the intermediate portion defining a passage therein which connects the first end to the second end, and the body is configured to rotate around the intermediate portion.

In one aspect, the module further comprises a motor, wherein actuation of the motor rotates the body in relation to the first and second ends. The motor is secured within the body, the motor operatively coupled to a driven gear secured to one of the first end or the second end.

In one aspect, the body has an outer diameter, the at least one sensor is configured to be moveable between a collapsed position where the at least one sensor is close to the body to an extended position where the least one sensor is away from the body and extends towards the pipeline wall. The at least one sensor is biased in the extended position and wherein an application of a force will move the at least one sensor to the collapsed position. When the at least one sensor is in the extended position, the at least one sensor is supported in a position substantially perpendicular to the longitudinal axis of the device.

In one aspect, the at least one sensor is configured to pivotally move between the extended position and the collapsed position.

In one aspect, the module further comprises a sensor housing moveably connected to the body and configured to mount the at least one sensor.

In one aspect, the sensor pivots about an axis orthogonal to the longitudinal axis of the module.

In one aspect, the least one sensor is a transducer. The transducer is an ultrasonic transducer that is configured to direct ultrasonic signals towards pipeline wall. In one aspect, there are two transducers and the two transducers are directed in opposed directions.

In one embodiment, there is provided a pipeline inspection device comprising a rotatable pipeline inspection module and a cable for tethering the device to a location outside of the pipeline. The device comprises at least one accessory module and a joint to flexibly connect the at least one accessory module to the rotatable pipeline inspection module. The at least one accessory module includes one or more of pipeline inspection components, buoyancy components, and electronic components.

In one embodiment, there is provided a method to assess the condition of a pipeline wall of a pipeline containing a liquid, the method comprising:
deploying a pipeline inspection device into a pipeline, the device comprising at least one sensor, the sensor configured to collect information useful for assessing the condition of a pipeline wall; and a body configured to mount the at least one sensor;
rotating the body as the device is carried by the liquid within the pipeline; and
obtaining, from the at least one sensor, information about substantially the wall of the pipeline during the rotation of the body, wherein the information is useful to assess to the condition of the pipeline wall.

In one aspect, the liquid is a moving liquid and the pipeline inspection device is carried by the moving liquid in the direction of flow.

In one embodiment, there is provided a method to assess the condition of the wall of a pipeline containing a liquid, the method comprising: deploying a rotatable inspection module into a pipeline, the module comprising at least one sensor, the at least one sensor configured to collect information useful for assessing the condition of the wall as the sensor is displaced a distance within the pipeline; and rotating the sensor about the longitudinal axis of the rotatable inspection module as the device is carried by the liquid within the pipeline; and obtaining, from the at least one sensor, information about substantially the entire interior surface of the pipeline during one or more complete revolutions of the at least one sensor of the rotatable inspection module along the displaced distance.

In one aspect, the module comprises ends coupled to a cable tethering the device to a location outside of the pipeline, and wherein when the sensor is caused to rotate about the longitudinal axis of the rotatable inspection module, the at least one sensor rotates in relation to the ends of the module.

In one aspect, the cable is configured to resist twisting.

In one aspect, the at least one sensor is a transducer. In one aspect, the transducer is an ultrasonic transducer.

In one embodiment, there is provided a pipeline inspection device comprising a rotatable pipeline inspection module to assess the condition of a pipeline wall when the module is deployed into a pipeline containing a liquid, the module comprising:
at least one sensor, the sensor configured to collect information useful for assessing the condition of a pipeline wall as the sensor is moved within the pipeline; and
a body configured to mount the at least one sensor; and
a cable secured to the device for tethering the device to a location outside of the pipeline; and wherein the body is actuatable to rotate in relation to the module.

### BRIEF DESCRIPTION OF THE DRAWINGS

FIG. 1 is a perspective view of a pipeline inspection device including a plurality of modules in accordance with an embodiment of the invention;

FIG. 2 is an enlarged perspective view of the device of FIG. 2 showing two modules, wherein one module in accordance with an embodiment of the invention is shown with equipment in an expanded position;

FIG. 3 is an enlarged view of the module of a pipeline inspection device of FIG. 2, shown with equipment in a collapsed position;

FIG. 4 is a perspective view of the module of FIG. 2, in which the portions of the body have been removed to show internal structure of one side of the module;

FIG. 5 is a cross sectional view along the line 5-5 in FIG. 4;

FIG. 6 is a cross sectional view along the line 6-6 in FIG. 4; and

FIG. 7 is a perspective view of the module of FIG. 2, in which the portions of the body have been removed to show internal structure of another side of the module.

### DETAILED DESCRIPTION

Reference will be made below in detail to exemplary embodiments of the invention, examples of which are illustrated in the accompanying drawings. Wherever possible, the same reference numerals used throughout the drawings refer to the same or like parts.

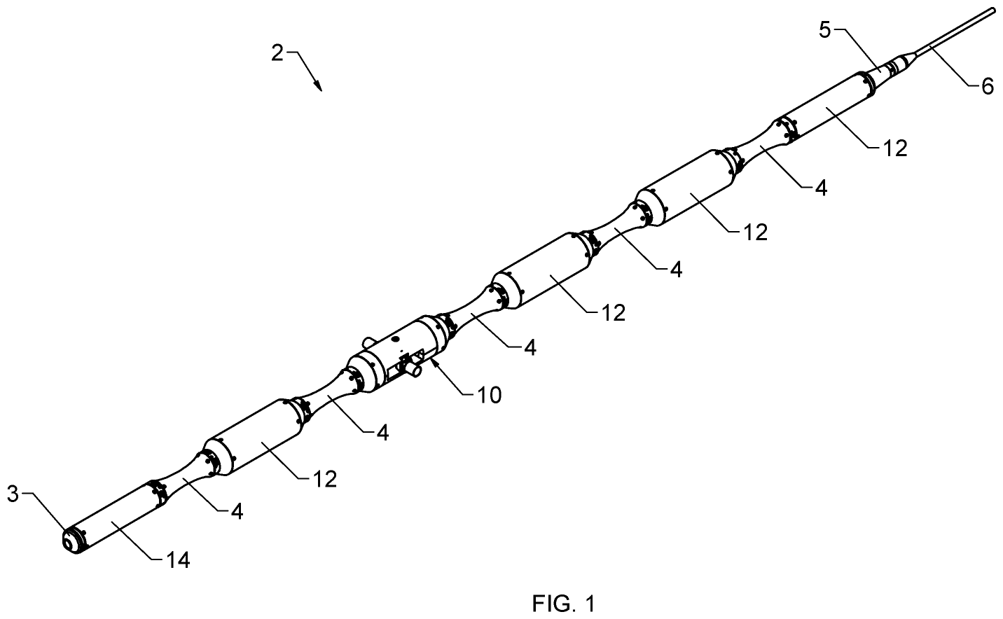

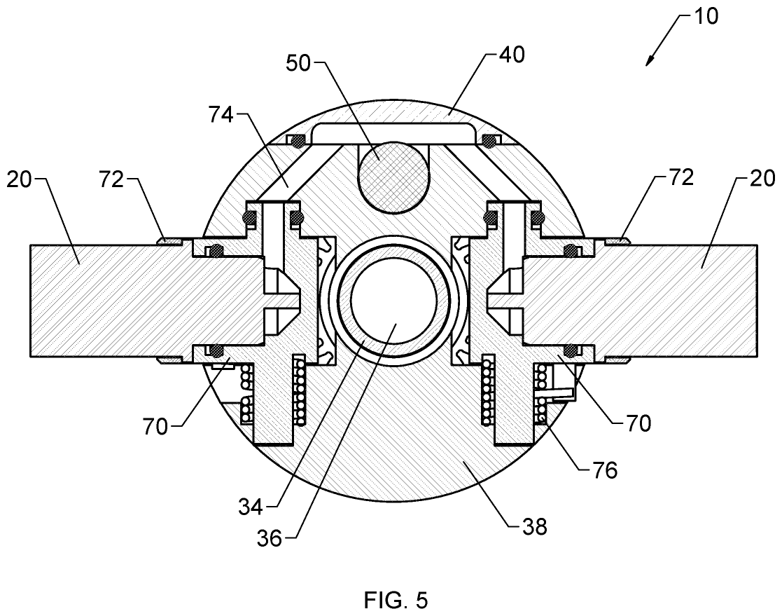

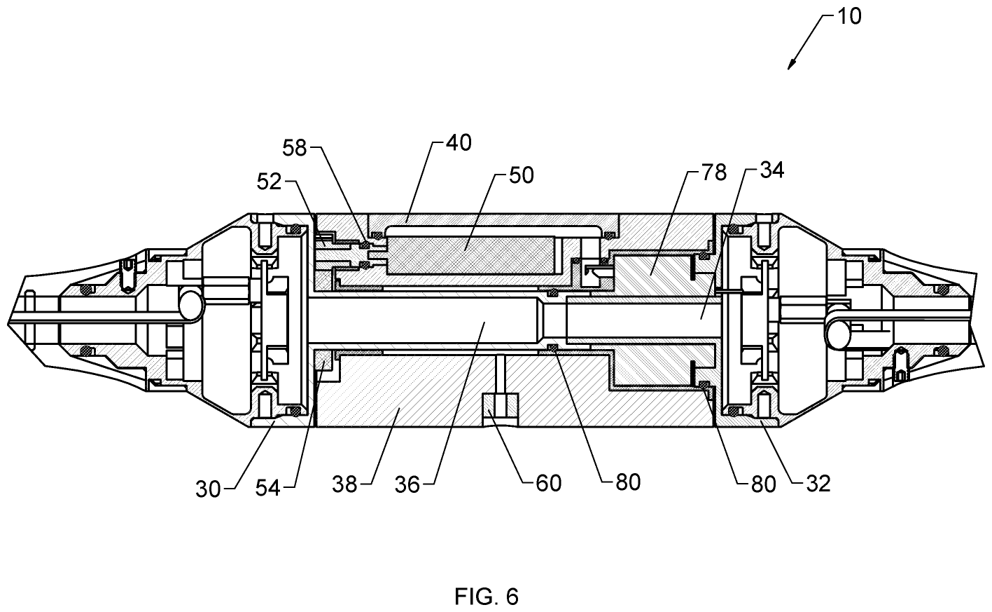

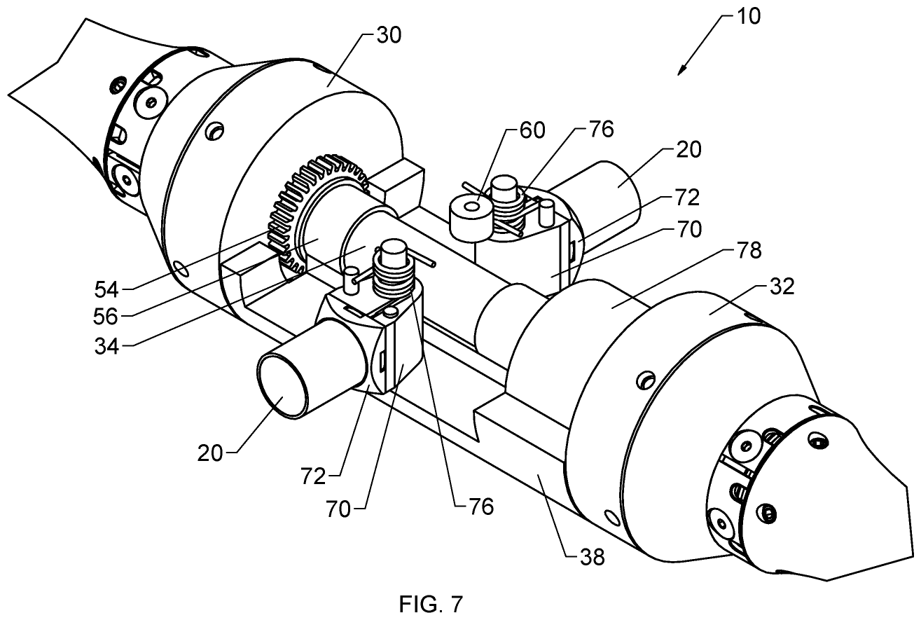

FIGS. 1 to 7 show a pipeline inspection device 2 that is deployable into a pipeline (not shown) to assess the condition of the wall of pipeline. The pipeline may be partially or completely filled with liquid and the liquid can be flowing. The device 2 comprises a forward section 3 and a rear section 5 opposite to the forward section 3. Device 2 further comprises one or more modules 10, 12, and 14 between the forward section 3 and the rear section 5. Modules 10, 12, and 14 may include any equipment 20 useful for collecting information about the condition of the pipeline, specifically, this equipment is useful for collecting information about various defects in the wall of the pipeline, such defects include, for example, metallic wall loss. Device 2 may include any number of modules and each of modules 10, 12, and 14 can contain similar equipment or different equipment, depending on the desired application. For example, module 10 can include sensory equipment 20 for collecting any one or all of optical, acoustic, and magnetic information useful for assessing the condition of the pipeline, module 14 can comprise video and fiber optic components, and module 12 can comprise buoyancy components that allow the device 2 to remain buoyant in the liquid containing pipeline and/or to house various electrical components to control and drive any components in module 10 and/or module 14 of device 2.

A cable 6 is coupled to the rear section 5 and is configured to tether the device 2 to an external location (not shown) outside of the pipeline when the device 2 is deployed inside the pipeline. Cable 6 may also be configured to carry electrical and/or fiber optic signals from one or more of the modules 10, 12, and 14 to the external location and/or deliver electrical power to one or more of the modules 10, 12, and 14. In some embodiments, while cable 6 is configured to have some flexibility, cable 6 can be configured to have some torsional rigidity so that cable 6 is be able to resist twisting or rotation. Cable 6 may be configured to withstand application of significant axial forces before breaking. Such a cable 6 will have a high breaking strength so that if the device 2 encounters and obstruction or is snagged, the operator may be able to apply a significant amount of force needed retract the device 2 before causing break. In one aspect, one or more axial loading members associated with cable 6 for increasing the breaking (tensile) strength are provided.

When a plurality of modules 10, 12, and 14 are used, the modules 10, 12, and 14 are connected to each other via connecting member (or joint) 4 which is configured to have some flexibility so that the modules 10, 12, and 14 of the device 2 can bend in relation to each other such that the device 2 can conform to the various bends of the pipeline that may be encountered during the deployment. The connecting member 4 may also be configured to have some torsional rigidity to resist twisting of modules 10, 12, and 14 in relation to each other. The connecting member 4 defines one or more internal passages (not shown) which are dimensioned to carry cabling (not shown), including for example, electrical cables for transmitting electronic signals between the plurality of modules 10, 12, and 14 and/or power cables for carrying electrical power from the external location to the plurality of modules 10, 12, and 14.

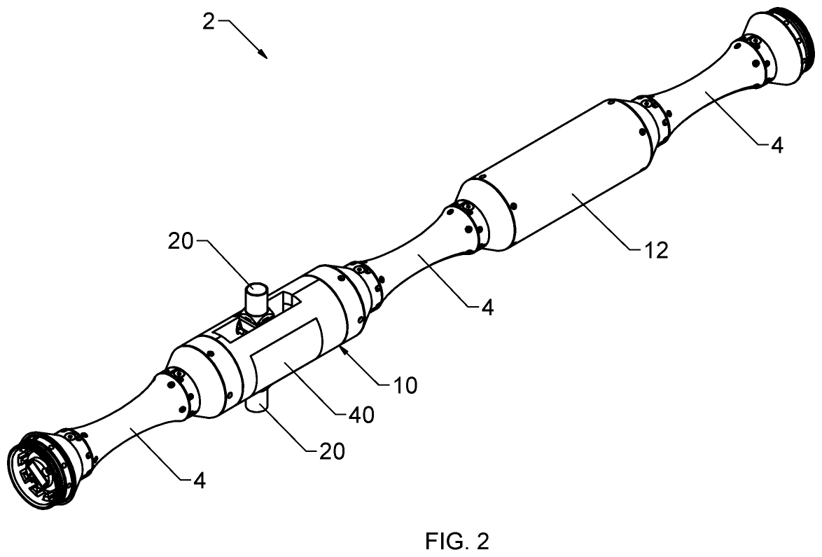

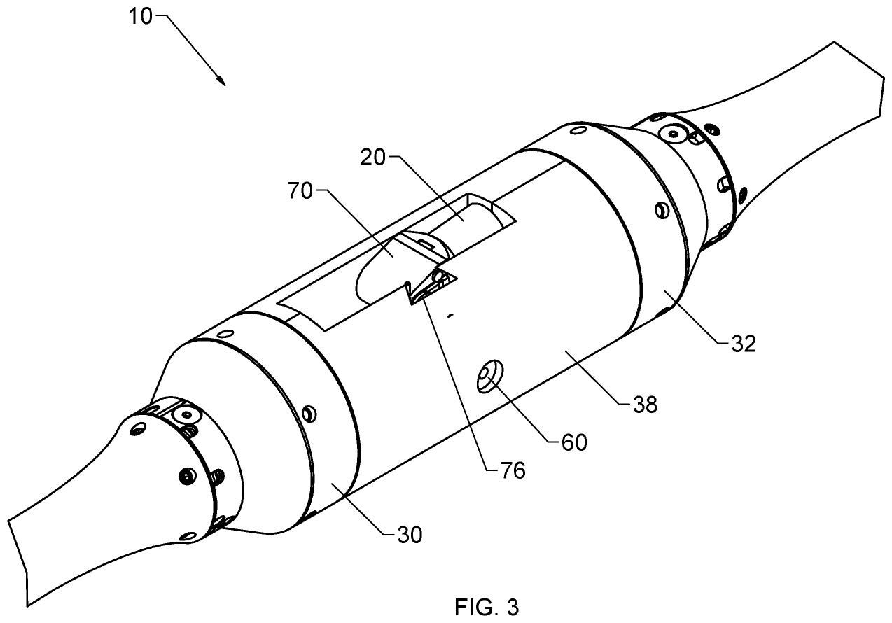

FIG. 2 shows a device 2 that includes module 10 that includes transducers 20 useful for collecting information about the condition of the pipeline. With reference to FIG. 2, the module 10 is shown with two transducers 20, with each transducer 20 being held in an extended position. FIG. 3 shows the module 10 with the two transducers 20, each transducer 20 maintained in a collapsed position.

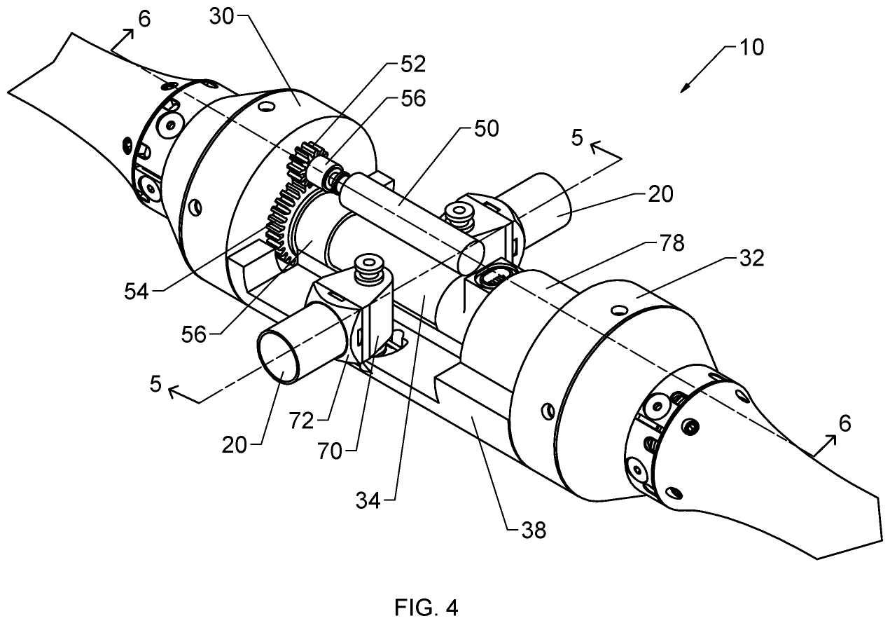

With reference to FIGS. 4 to 7, module 10 is a substantially elongate member having a first end 30 and an opposed second end 32, the ends 30, 32 being configured to connect to a respective connecting member 4. The first and second ends 30, 32 are joined by an intermediate portion 34 that defines an internal passage 36 dimensioned to house cabling, such as for example, electrical cables for carrying various electronic signals or power cables from between the first and the second ends 30, 32, and vice versa.

Module 10 comprises a body 38, between the first and second ends 30, 32. The body 38 is configured to rotate about the longitudinal axis of the device 2. In the embodiment shown, when the body 38 is caused to rotate, the rotational movement can be understood having reference to ends 30, 32 which remain relatively stationary. The body 38 will also rotate around the intermediate portion 34 joining the ends 30, 32. At least one of ends 30, 32 is operatively attached to cable 6. Operatively attached means that at least one of ends 30, 32 is connected to cable 6 either directly or indirectly via one or more connecting members 4 and/or one or more other modules 10, 12 or 14.

Body 38 includes at least one access hatch 40 for allowing access to interior portions of the body 38 where various components may be secured, as detailed below.

Module 10 comprises a motor 50 which can be secured within the body 38, such as for example, a Maxon DC motor, for moving a drive gear 52, such as a nylon spur drive gear 52. A driven gear 54 can be secured to at least one of the ends 30, 32 by a sleeve bearing 56, for example. The driven gear 54 is operatively coupled to the drive gear 52, wherein when the motor 50 is actuated, the drive gear 52 will begin to rotate. Since the ends 30, 32 of the module are configured to remain resistant, or substantially resistant, to rotation, the rotation of the drive gear 52 will cause this gear to rotate around the driven gear 54 such that the body 38 will move relative to the ends 30, 32 and rotate around the intermediate portion 34. Rotary seal 58 is provided to separate the motor 50 from the outside environment. A counter weight 60 is provided opposite the position of the motor 50 to balance the center of gravity and to reduce undesired vibration.

As shown in FIGS. 1 to 7, upon actuation of motor 50, the body 38 will begin to rotate in relation to ends 30, 32 which will remain relatively stationary. This is because the ends 30, 32 are operatively attached to cable 6 which resists rotation and/or twisting. Accordingly, the body 38 will rotate (either clockwise or counterclockwise) about the longitudinal axis of the device 2 and since the device 2 is secured to cable 6, the body 38 can also be seen as rotating in relation to cable 6.

Module 10 includes one or more sensory equipment 20 useful for collecting information about the condition of the pipeline. In one embodiment, the sensory equipment 20 is one or more sensors 20. As shown in FIGS. 1 to 7, the sensors 20 are transducers 20. Transducers 20 are mounted to transducer housing 70 and the transducers are secured to the housing 70 by a transducer retainer 72. Transducer housing 70 is moveable between a first position where the transducers 20 assume an extended position away from the body 38 and a second position where the transducers 20 assume a collapsed position close to the body 38. As shown in FIGS. 4 to 7, transducer housing 70 is pivotally moveable in relation to the body 38 in either direction (i.e. in a direction towards the first end 30 and/or towards the second end 32). While transducer housing 70 and thus transducers 20 are shown to pivotally move between the extended position and the collapsed position, it will be understood that the movement can be any movement (e.g. sliding or rotation) that can move the transducers away from the body 38 and can retract the transducers 20 from the extended position into the collapsed position close to the body 38.

In some embodiments, the extended position permits the transducers 20 to collect the sensory information required to assess the conditions of the pipeline, such as for example, the metallic wall loss of the interior and exterior walls of pipeline. In aspects, the extended position allows transducers 20 to be closer to the pipeline wall.

In the collapsed position, the transducers 20 can be substantially recessed into the body 38 and do not substantially extend beyond the outer diameter of the module 10, which in some exemplary embodiments is about 2.25″. In some embodiments, the collapsed position allows the device 2 to be more easily transported and then inserted into the pipeline, and retracted out from the pipeline, which may only have narrow access points and/or travel within the pipeline such that transducers 20 do not become snagged on features of the pipeline.

According to one embodiment, in the extended position, the transducers 20 are arranged approximately perpendicular to a longitudinal axis of the module 10. Two 90 degree torsion springs 76 keep each transducer 20 in the perpendicular position until it is desired to move the transducers 20 into the collapsed configuration. In an embodiment, the transducers 20 are biased into the extended position and can be caused to move into the collapsed position upon an application of a force and wherein removal of the force will cause the transducers 20 move back into the extended position. In certain embodiments, it may be desirable to collapse the transducers 20 during the pipeline insertion or removal process to minimize their contact with the features of the pipeline that may contact and/or damage the transducers 20. Once the device 2 is deployed into the pipeline, the transducers 20 can then allowed to assume the extended position.

In some aspects, the transducers 20 direct ultrasonic signals towards the pipeline wall. Reflections, which may be in multiples, can also be received by the transducers 20. The reflected signal(s) are then analyzed to obtain information about the conditions of the pipeline. The conditions can be, but are not limited to, variations in ovality, liner thickness and delamination, pipeline wall thickness and defects, and location of air pockets, valves, laterals or other pipeline features.

In some aspects, rotation of the transducers 20 may increase resolution because during one complete revolution of the body 38, the transducers 20 will be able to direct and/or receive signals that span across substantially the entire interior surface of the pipeline wall in the area in which the device 2 is located. Since the device 2 is carried by the liquid in the pipeline and will travel some distance away from the point of deployment, the rotating transducers 20 will be able to obtain information about the conditions across the interior surface of the pipeline along the entire length of travel within the pipeline.

In some aspects, the movement of the transducers 20 into the extended position and away from the body 38 of the device 2 may increase resolution because the transducers 20 will be closer to the interior surface of the pipeline wall.

A cable channel 74 is formed in the body 38 and/or transducer housing 70 to operatively connect the transducers 20 to any cabling contained in the passage 36 defined by the intermediate portion 34 connecting the first end 30 to the second end 32.

Module 10 includes a rotary electrical joint 78. According to one embodiment, the rotary electrical joint is a MOOG SRA-73683 slip ring connector. Seals 80 are provided to keep moisture from entering into the passage of the intermediate portion 34 or otherwise interfere with any other electronic components. Access hatch 40 can be configured to allow direct access to the electrical joint 78.

A rotary encoder (not shown) is used to provide the relative position of the transducers 20 during a transmitting and receiving sequence.

Module 10 is depicted with two sensors 20, however, module 10 can have any number of sensors 20 as required for the particular application. The exemplary sensors 20 are transducers 20, but transducers 20 are only one example of a suitable sensor 20. It would be understood that the present application is not limited to transducers 20, but the sensor 20 can be any equipment useful for collecting information about various defects in the wall of the pipeline.

Module 10 and/or body 38 can be made, for example, from HDPE or some other sufficiently durable material capable of protecting the various components from applied pressure and/or axial loads. Other suitable materials, include, but are not limited to aluminum.

The device 2 can also include one or more buoyancy components (not shown) configured to provide buoyancy to the device 2. For example, buoyancy components may be included in any one or more of modules 10, 12, and 14.

In use, device 2 comprising a rotatable inspection module 10 including one or more transducers 20 is secured to cable 6. Device 2 is then lowered and deployed into the liquid-containing pipeline with the cable 6 tethering the device 2 to the surface. The device 2 is carried by the liquid and is displaced a distance along a length of the pipeline. The transducers 20 are caused to rotate about the longitudinal axis of the module 10 during the displacement such that information useful to assess to the condition of the wall is obtained substantially across the wall of the pipeline during one or more complete revolutions of the transducers 20 of the module 10 along the displaced distance.

The embodiments of the present application described above are intended to be examples only. Those of skill in the art may effect alterations, modifications and variations to the particular embodiments without departing from the intended scope of the present application. In particular, features from one or more of the above-described embodiments may be selected to create alternate embodiments comprised of a subcombination of features which may not be explicitly described above. In addition, features from one or more of the above-described embodiments may be selected and combined to create alternate embodiments comprised of a combination of features which may not be explicitly described above. Features suitable for such combinations and subcombinations would be readily apparent to persons skilled in the art upon review of the present application as a whole. Any dimensions provided in the drawings are provided for illustrative purposes only and are not intended to be limiting on the scope of the invention. The subject matter described herein and in the recited claims intends to cover and embrace all suitable changes in technology.

1. A rotatable pipeline inspection module to assess the condition of a pipeline wall when the module is deployed into a pipeline containing a liquid, the module comprising:
at least one sensor, the sensor configured to collect information useful for assessing the condition of a pipeline wall as the sensor is moved within the pipeline; and
a body configured to mount the at least one sensor, wherein the module is operatively securable to a cable for tethering the module to a location outside of the pipeline; and wherein the body is actuatable to rotate in relation to the module when the module is secured to the cable.

2. The rotatable pipeline inspection module of claim 1, wherein the module further comprises a first end and a second end opposed to the first end, wherein the body is located between and moveable in relation to the first and second ends, and wherein the cable is secured to one of the first and second ends.

3. The rotatable pipeline inspection module of claim 2, wherein the module further comprises an intermediate portion between the first and second ends, the intermediate portion defining a passage therein which connects the first end to the second end, and the body is configured to rotate around the intermediate portion.

4. The rotatable pipeline inspection module of claim 3, further comprising a motor, wherein actuation of the motor rotates the body in relation to the first and second ends.

5. The rotatable pipeline inspection module of claim 4, wherein the motor is secured within the body, the motor operatively coupled to a driven gear secured to one of the first end or the second end.

6. The rotatable pipeline inspection module of claim 1, wherein the body has an outer diameter, the at least one sensor is configured to be moveable between a collapsed position where the least one sensor is close to the body to an extended position where the least one sensor is away from the body and extends towards the pipeline wall.

7. The rotatable pipeline inspection module of claim 6, wherein the at least one sensor is biased in the extended position and wherein an application of a force will move the at least one sensor to the collapsed position.

8. The rotatable pipeline inspection module of claim 7, wherein when the at least one sensor is in the extended position, the at least one sensor is supported in a position substantially perpendicular to the longitudinal axis of the device.

9. The rotatable pipeline inspection module of claim 1, wherein the at least one sensor is configured to pivotally move between the extended position and the collapsed position.

10. The rotatable pipeline inspection module of claim 9, further comprising a sensor housing moveably connected to the body and configured to mount the at least one sensor.

11. The rotatable pipeline inspection module of claim 10, wherein the sensor pivots about an axis orthogonal to the longitudinal axis of the module.

12. The rotatable pipeline inspection module of any one of claim 1, wherein the least one sensor is a transducer.

13. The rotatable pipeline inspection module of claim 12, wherein the transducer is an ultrasonic transducer configured to direct ultrasonic signals or to direct and to receive ultrasonic signals towards pipeline wall.

14. The rotatable pipeline inspection module of claim 13, comprising two transducers and the two transducers are directed towards opposed directions.

15. A pipeline inspection device comprising:
a rotatable pipeline inspection module to assess the condition of a pipeline wall when the module is deployed into a pipeline containing a liquid, the module comprising:
at least one sensor, the sensor configured to collect information useful for assessing the condition of a pipeline wall as the sensor is moved within the pipeline;
a body configured to mount the at least one sensor; and
a cable secured to the device for tethering the device to a location outside of the pipeline; and wherein the body is actuatable to rotate in relation to the module.

16. The pipeline inspection device of claim 15, comprising at least one accessory module and a joint to flexibly connect the at least one accessory module to the rotatable pipeline inspection module.

17. The pipeline inspection device of claim 16, wherein the at least one accessory module includes one or more of pipeline inspection components, buoyancy components, and electronic components.

18. A method to assess the condition of a pipeline wall of a pipeline containing a liquid, the method comprising:
deploying a pipeline inspection device into a pipeline, the device comprising at least one sensor, the sensor configured to collect information useful for assessing the condition of the pipeline wall; and a body configured to mount the at least one sensor;
rotating the body as the device is carried by the liquid within the pipeline; and
obtaining, from the at least one sensor, information about substantially the wall of the pipeline during rotation of the body, wherein the information is useful to assess the condition of the pipeline wall.

19. The method of claim 18, wherein the liquid is a moving liquid and the pipeline inspection device is carried by the moving liquid in a direction of flow.

20. The method of claim 18, wherein the wall is the interior surface and exterior surface.

21. The method of claim 18, wherein the pipeline inspection device comprises at least one accessory module and a joint to flexibly connect the at least one accessory module to the rotatable pipeline inspection module.

22. The method of claim 21, wherein the at least one accessory module includes one or more of pipeline inspection components, buoyancy components, and electronic components.
